(19) United States
(12) Patent Application Publication
(10) Pub. No.: US 2018/0139904 A1
(43) Pub. Date: May 24, 2018

(54) TOP-SPREAD BALE SPREADER

(71) Applicant: TOP-NOTCH MACHINE, LLC, Charles City, IA (US)

(72) Inventors: Steve Smith, Charles City, IA (US); Jason Agnitsch, Charles City, IA (US); Eric Crabtree, Nashua, IA (US); Emily Smith, Charles City, IA (US)

(21) Appl. No.: 15/355,635

(22) Filed: Nov. 18, 2016

(51) Int. Cl. A01F 29/00; A01F 29/14; A01F 29/02; A01F 29/12; B02C 13/02; B02C 13/20; B02C 18/06; B02C 13/286; B02C 23/08

(52) U.S. Cl. CPC A01F 29/005; A01F 29/14; A01F 29/02; A01F 29/12; B02C 2013/28636; B02C 13/20; B02C 18/06; B02C 13/286; B02C 23/08; B02C 13/02

(57) ABSTRACT

A bale spreader including one or more rotors rotatably attached to a first and second support member is provided. The bale spreader includes an apron that extends below the rotor(s), and may be configured to operatively feed a particulate material into the rotor(s). The rotor(s) may include a plurality of flail knives or hammers configured to chop and/or shred a particulate material as the rotor(s) is/are rotated. The rotor(s) may be rotated by an optimized hydraulic system connected to the auxiliary hydraulic system of an agricultural implement or vehicle. Furthermore, the bale spreader may include a plurality of tines, screen members, and a flop bar configured to secure particulate material within the bale spreader.

### FIELD OF THE INVENTION

The invention relates generally to an agricultural implement. More specifically, but not exclusively, the invention relates to an agricultural implement for spreading particulate material. Even more specifically, but not exclusively, the invention relates to a bale spreader comprising one or more rotors for chopping and spreading particulate material.

### BACKGROUND OF THE INVENTION

Bale spreaders are known in the art. Existing spreaders either do not chop the product, or they are limited in the amount of product that may be chopped and how fine the bale is chopped. Similarly, existing bale spreaders can be long, balky, and unbalanced, resulting in them being difficult to operate and maneuver in closed or confined spaces. The configuration of existing bale spreaders can also create issues and additional strain on the power source, caused by the excessive length of hydraulic lines and/or a large number of bends created in routing the hydraulic lines.

Also, existing spreaders that utilize spinners generally provide a limited distance within which the product is spread during operation. Furthermore, after chopping and spreading a bale, similar bale spreaders require manual labor to clean out any residual product remaining on or in the spreader. As a result, a need exists for a device that addresses these deficiencies.

Therefore, there exists a need in the art for a bale spreader capable of chopping and spreading a particulate material, such as hay or straw, saw dust, wood chips, corn fodder, which overcomes the deficiencies in the art.

### BRIEF SUMMARY OF THE INVENTION

Therefore, it is a primary object, feature, and/or advantage of the invention to improve on and/or overcome the deficiencies in the art.

It is another object, feature, and/or advantage of the invention to provide a bale spreader comprising a base with left, right, front, and back edges, and opposing first and second support members that extend from the front edge, wherein one or more rotors are operably positioned between the left and right support members.

It is yet another object, feature, and/or advantage of the invention to provide a bale spreader comprising one or more rotors operably positioned between a first and second support member, wherein at least one of the one or more rotors comprises a double sprocket and the one or more rotors are interconnected by one or more drive chains.

It is a further object, feature, and/or advantage of the invention to provide a bale spreader wherein the base comprises a left side rail extending from the left edge, a right side rail extending from the right edge, and a rear side rail extending from the rear edge.

It is still a further object, feature, and/or advantage of the invention to provide a bale spreader wherein the one or more rotors include a top rotor and a bottom rotor, wherein said rotors are oriented horizontally between the first and second support members.

It is still yet a further object, feature, and/or advantage of the invention to provide a bale spreader wherein the one or more rotors are staggered relative to one another along a generally vertical axis.

It is still yet a further object, feature, and/or advantage of the invention to provide a bale spreader with a flop bar removably attached to the rear edge of the base and/or the rear side rail, wherein the flop bar is configured to extend in a generally vertical direction to secure a particulate material on or within the bale spreader.

It is still yet a further object, feature, and/or advantage of the invention to provide a bale spreader wherein the one or more rotors comprise a plurality of flail hammers and/or knives that are removably attached to the rotors.

It is still yet a further object, feature, and/or advantage of the invention to provide a bale spreader comprising an attachment member/plate configured to removably secure the bale spreader to an agricultural implement, such as a tractor or skid loader. Said attachment member may be attached to the left, right, and/or rear rails of the bale spreader.

It is still yet a further object, feature, and/or advantage of the invention to provide a bale spreader comprising a plurality of tines extending from the left, right, and/or rear rails. Said tines preferably attached to the rail opposite the attachment member/plate. The tines may also include a screen member extending between adjacent tines and configured aid in the loading and securing of loose particulate material(s).

It is still yet a further object, feature, and/or advantage of the invention to provide a bale spreader wherein the top and bottom rotors are staggered relative to a generally vertical axis.

It is still yet a further object, feature, and/or advantage of the invention to provide a bale spreader comprising an apron including a pintle chain configured to feed particulate material into/toward the rotors or away from the rotors. The apron may include bars and paddles that are configured to aid in feeding the particulate material into the rotors.

It is still yet a further object, feature, and/or advantage of the invention to provide a bale spreader comprising a rubber vacuum attached to a hood extending between the first and second support members. The vacuum may be configured to hold the vacuum effect created by the rotation of the rotors.

It is still yet a further object, feature, and/or advantage of the invention to provide an agricultural implement comprising a base with a left, right, front, and rear edge, wherein first and second support members are positioned proximate to the front edge of the base and extend in a generally vertical direction. The bale spreader further comprises top and bottom rotors that are operatively positioned between the first and second support members. A double sprocket or a whole hub unit is operatively attached to the bottom rotor and configured to translate rotational movement of the drive sprocket to the sprocket attached to the top rotor.

It is still yet a further object, feature, and/or advantage of the invention to provide a bale spreader comprising a base with a left, right, front, and rear edge, wherein opposing first and second support members are positioned proximate to the front edge of the base and extend in a generally vertical direction. A rear rail may extend from the rear edge of the base, and a flop bar may be removably attached to the rear rail. The flop bar may be configured to secure particulate material within the spreader. The bale spreader further comprises a rotor operatively positioned between the first and second support members.

Accordingly, one aspect of the invention includes an agricultural implement knows as a bale spreader. The bale spreader may include an attachment member or plate configured to removably secure the spreader to a tractor or skid loader. The bale spreader includes a base with rails extending vertically at the perimeter of the left, right and rear edges of the base. Opposing first and second support members are positioned proximate to the front edge of the base and extend in a generally vertical direction. Operatively positioned between the first and second support members are one or more rotors. The rotor(s) may include a plurality of removably attached flail knives or hammers configured to chop or shred a particulate material and discharge the shredded material as the rotor(s) are rotated.

Furthermore, the spreader may include a plurality of tines extending from the edge or the base or the rail(s). The tines may be configured to assist in picking up a bale of straw or other particulate material to be place in the spreader. The tractor or skid loader that is attached to the bale spreader may rotate or manipulate the spreader so that the tines my by slid under the bale, and then as the spreader is rotated back to the upright position, the bale will be placed/secured within the spreader. The tines are typically evenly spaced along the edge of the base or rail, and extend in a generally outward and upward direction relative to the center of the spreader. The tines may also include one or more screen members that can be placed between adjacent tines or attached independently to any of the rails. A flop bar may also be removably attached to the rail(s) to secure particulate material within the bale spreader.

However, the present invention also includes a hydraulic system including one or more hydraulic motors configured to rotate the rotor(s) and/or the pintle chain of the apron. The routing of the lines of the hydraulic system has been optimized to reduce the length of the hydraulic hoses/lines, and to limit the bends and kinks in the lines. The size of the lines and fittings have also been optimized to allow the hydraulic system to operate at a cooler temperature. A case drain has also been added to the hydraulic system to reduce the stresses and pressures on the hydraulic motor(s)/system.

These and/or other objects, features, and advantages of the invention will be apparent to those skilled in the art. The invention is not to be limited to or by these objects, features and advantages. No single embodiment need provide each and every object, feature, or advantage.

### BRIEF DESCRIPTION OF THE DRAWINGS

FIG. 1 is a perspective view of a bale spreader.

FIG. 2 is a top perspective view of the bale spreader of FIG. 1.

FIG. 3 is a sectional view of the bale spreader of FIG. 1.

Various embodiments of the invention will be described in detail with reference to the drawings, wherein like reference numerals represent like parts throughout the several views. Reference to various embodiments does not limit the scope of the invention. Figures represented herein are not limitations to the various embodiments according to the invention and are presented for exemplary illustration of the invention.

### DETAILED DESCRIPTION

The invention is generally directed, but not exclusively, towards a bale spreader 10 comprising one or more rotors for chopping and spreading particulate material.

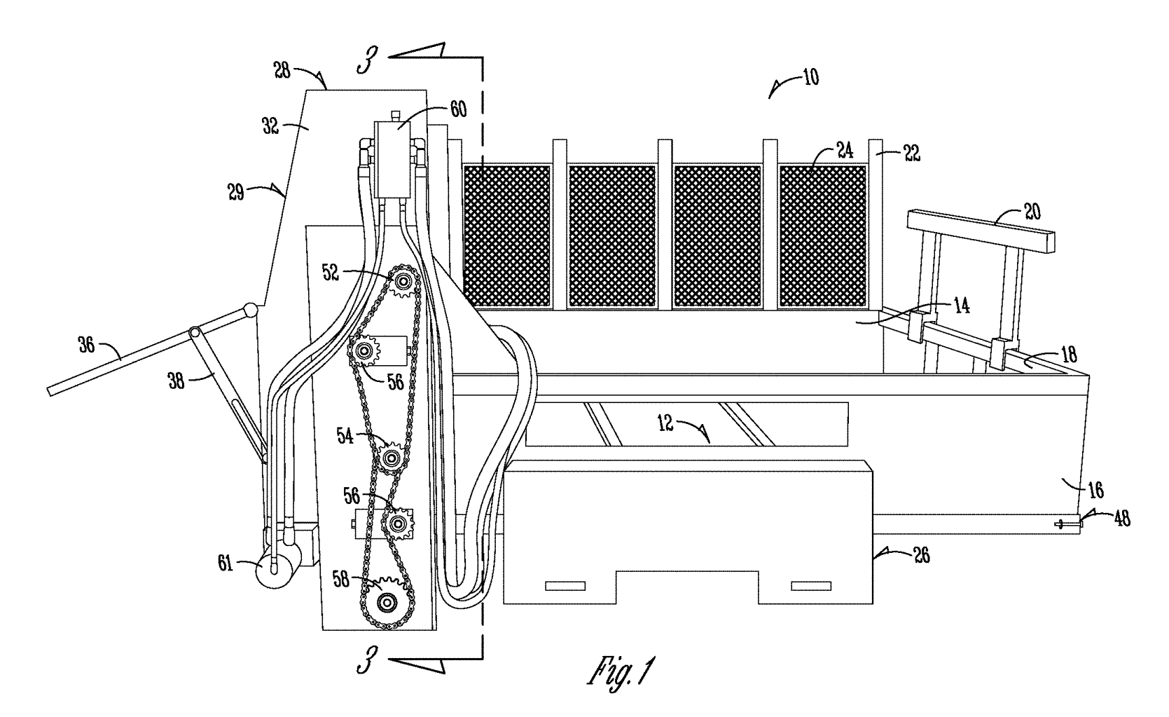

Referring to the Figures, a bale spreader 10 comprising a base or bed 12 and one or more rails 14, 16, and 18 is shown. FIG. 1 is a perspective view of the bale spreader 10. The base 12 is generally flat and extends the length and width of the bale spreader 10. The size of the base 12 may vary depending on the application. For example, the base 12 may be six foot long if configured to handle smaller round bales of hay or straw. Alternatively, the base 12 may be 8 feet or longer if configured to handle larger square/rectangular shaped bales. Extending from the perimeter or edge of the base 12 are a right rail 14, left rail 16, and a back rail 18. The rails 14, 16, and 18 are configured to extend in a generally perpendicular direction from the base 12. The rails 14, 16, and 18 provide support to the base 12, and prevent a bale of straw/hay or other particulate material from falling off the base 12. The rails 14, 16, and 18 may be constructed from a steel tubing or piping to create a frame. The rails 14, 16, and 18 may also be constructed of sheet material. For example, the rails 14, 16, and 18 may be constructed from a metal alloy, aluminum, carbon fiber, polycarbonate material, or other material that provides a similar rigidity and wear factor.

A number of other items may be attached to the base 12 and/or rails 14, 16, and 18. For example, the bale spreader may include one or more tine members 22 extending from the right rail 14. While not shown in the Figures, it should be understood that the tine members 22 may be attached to the left rail 16 and the rear rail 18. In a preferred embodiment, a plurality of tine members 22 extend vertically from the right rail 22. The tines 22 may extend straight up from the rail 14, or the tines 22 may be configured to extend in an upward and outward direction, wherein they are angled away from the base. For example, the tine 22 may be include an interior angle of approximately 100 degrees relative to the base 12. Alternatively, the tine 22 may have an exterior angle of 85 degrees relative the plane created by the base 12. The tines 22 may be evenly spaced along the rail 14, or they may be spaced at varying increments along the rail 14 to serve a specific purpose. In an example embodiment, the tines 22 may be spaced approximately sixteen inches (16″) apart. The tines 22 are configured to aid in picking up a bale or other particulate material. For example, when the bale spreader 10 is attached to a farm implement, such as a skid loader or tractor, the bale spreader may be rotated so that the tines 22 may be utilized as forks to pick up a bale. The tines 22 may be slid under the bale, and then when the bale spreader 10 is rotated back to the upright position, the bale or other particulate material will be placed on the base or bed 12 of the bale spreader. This can greatly reduce the amount of physical exertion required by a person to load a large bale of straw/hay or other particulate material into the bale spreader 10. The outward angle of the tines 22 may also serve to funnel a bale or particulate material down to the base 12, so that it may be fed into the rotors 40 and 42.

The tines 22 may also include one or more screen members or panels 24 inserted between adjacent tines 22. The screen member 24 may also be constructed as a solid member that extends the length of the rail 14 and is attached to the outer surface of the tines 22. The screen member(s) may be configured to aid in the picking up of a bale with the tines 22, and it may also aid in preventing the loss of particulate material that may have otherwise fallen off the bale spreader 10. While not shown in the Figures, it should be understood that the screen member(s) 24 may also be attached to and extend from the left rail 16 and the rear rail 18. For example, if the screen member 24 were added to the left rail 16 of the embodiment depicted in FIG. 1, the screen member 24 would provide additional protection to the person driving the skid loader or tractor that the bale spreader 10 is attached to.

As discussed above, the bale spreader 10 may be attached to a skid loader, tractor, front-end loader, or other similar agricultural implement/vehicle. One method of attaching a bale spreader to an agricultural vehicle is shown in U.S. patent application Ser. No. 14/834,083, which is herein incorporated by reference in its entirety. The bale spreader 10 may include an attachment plate 26. The attachment plate may be attached to the base 12 or the rails 14, 16, and 18. In FIG. 1, the attachment plate is shown attached to the left rail 16, opposite the tines 22. However, it should be understood that the attachment plate 26 may be attached to the left, right or rear side of the bale spreader 10. In a preferred embodiment, the attachment plate 26 is attached opposite the tines 22 to allow the agricultural vehicle to rotate and manipulate the bale spreader to pick up a bale or other particulate material with the tines 22. The attachment plate 26 may be configured to removably attach the bale spreader to the hydraulic arms of a skid loader or tractor. For example, the hydraulic arms of a tractor or skid loader may be inserted into and/or hook to the attachment plate.

The rails 14, 16, and/or 18 may include a flop bar 20. The flop bar may be removably attached to the rail(s) 14, 16, and/or 18, and extend in a generally vertical direction. The flop bar 20 may be a metal frame, tubing, or metal bars. The bars may comprise from a metal alloy, aluminum, carbon fiber, polycarbonate material, or other material that provides a similar rigidity. The flop bar 20 can prevent a bale or other particulate material from rolling off the base 12 of the spreader 10.

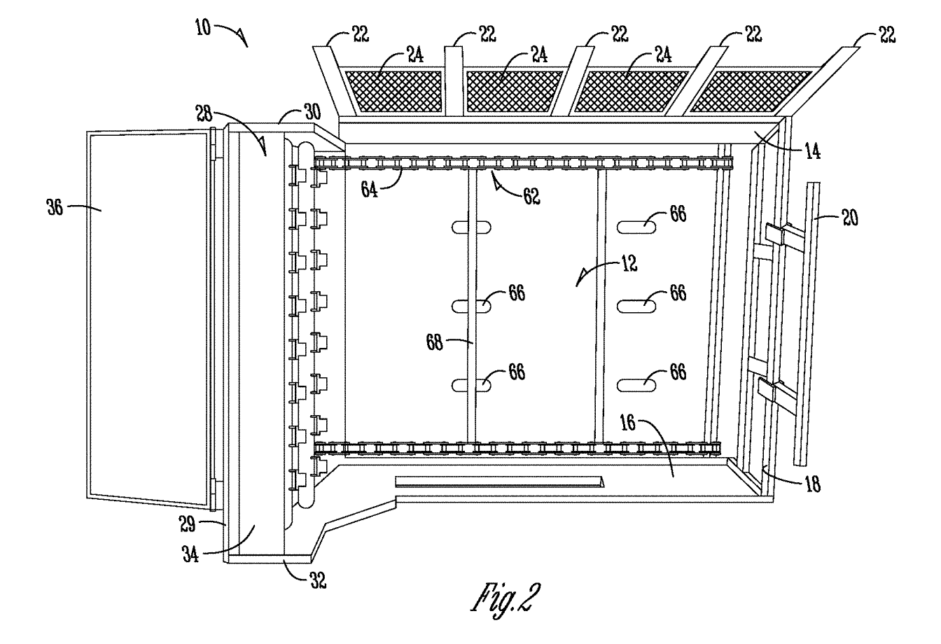

As shown in FIG. 2, opposite the rear rail 18, there is a first support member 30 and a second support member 32 that extend vertically from the base 12. Mounted between the support members 30 and 32 are a pair of rotors, a top rotor 40 and a bottom rotor 42. The rotors 40 and 42 are rotatably mounted to the support members 30 and 32 with a bearing securing the opposing ends of the rotors 40 and 42 to the opposing support members 30 and 32. While not shown in the figures, it should be understood that additional rotors may be utilized if desired. The top rotor 40 and the bottom rotor 42 may be staggered relative to a generally vertical axis. For example, the top rotor 40 may be positioned toward the rear of the base 12 and the bottom rotor may be positioned toward the front of the base, and vice versa. Staggering the rotor 40 and 42 may provide advantages in feeding the bale or particulate material through the spreader, as well as provide advantages in how effectively a bale is chopped or shredded prior to discharge. The vertical distance between the rotors may also be adjusted to provide advantages in the shredding/chopping and/or spreading of the particulate material. For example, positioning the bottom rotor 42 toward the front of the spreader 10 and the top rotor 40 toward the rear of the spreader 10 may more effectively feed a large round bale through the spreader 10.

The rotors 40 and 42 may include removably attached flail knives, hammers, blades, or teeth 44. The hammers 44 are configured to chop and/or shred bale or other particulate material as the rotors 40 and 42 are rotated. The flail hammers 44 may also be rotatably/swingingly attached or stationary on the rotors 40 and 42. The hammers 44 are likely to become worn over time, therefore the hammers 44 are removably attached to allow the user to quickly and easily change worn hammers 44 and replace them with new ones. This also allows for the knives/hammers 44 to be switched out to perform a specific chopping or shredding operation. For example, a thicker and/or bulkier hammer 44 may be installed to chop/shred a tougher or heavier particulate material. Alternatively, a sharper knife may be installed to more finely chop a particulate material.

The rotors 30 and 32 are connected to and driven by an auxiliary hydraulic system of the agricultural implement/vehicle that the bale spreader 10 is attached to. The bale spreader may include a hydraulic motor 61 attached to a drive sprocket 58 that is configured to drive the rotors 40 and 42. In one embodiment, the hydraulic motor 61/system 60 is positioned behind or next to the drive sprocket 58 shown in FIG. 1. This protects the hydraulic motor 61 from being damaged during operation of the spreader 10. Furthermore, the hydraulic lines may be routed to reduce the length of the lines, as well as to avoid sharp bends. This can reduce the stresses and pressure within the lines, allowing the hydraulic system 60 to operate more efficiently and at a cooler temperature. As shown in FIG. 1, the hydraulic system 60 is designed to reduce the length of the hydraulic lines, while still allowing for them to easily be connected to the auxiliary hydraulic system of a skid loader proximate to the attachment plate 26. In a preferred embodiment, the hydraulic system may include three-quarter inch (¾″) ports and hoses for connecting the auxiliary hydraulic system 60 to the hydraulic/rotor motor 61. In testing, this has been shown to provide approximately 400 RPM (rotations per minute) more speed than previous models, reaching approximately 1,680 RPM. The larger ports and hoses allow the hydraulic system to operate at a cooler temperature, which in turns allows for longer run times without damaging the hydraulic motor 61 or system 60. A case drain may also be added on first series motor 61 to allow more flow and less strain on the hydraulic motor 61. Case drain lines are generally used to relieve any excess pressure build-up in the hydraulic motor 61. Check valves can also be added to prevent loss of flow and backward directional flow within the hydraulic system 60. A hydraulic block flow divider may be utilized to regulate the flow to apron conveyor 62 and full flow for rotor motor 61.

When connected to the auxiliary hydraulic system of a skid loader or other farm implement, hydraulic oil will be pumped through the hydraulic system 60, which will rotate a drive sprocket or pulley 58. It should be understood that a sprocket and chain or a belt and pulley system may be used interchangeably to rotate the rotors 40 and 42. The drive sprocket 58 may be connected to the rotors 40 and 42 by one or more chains or belts. For example, as shown in FIG. 1, the drive sprocket 58 is attached to the bottom sprocket 54 of the bottom rotor by a chain. The chain may be tightened by a tensioner sprocket or pulley 56. The tensioner 56 may be adjusted by loosening or tightening a bolt. For example, tightening the bolt may apply additional pressure or force to the chain or belt, removing any slack. Alternatively, loosening the bolt may remove pressure on the chain or belt, allowing the chain or belt to be removed and/or replaced. The bottom sprocket 54 may be a double sprocket 54 or pulley. As shown in FIG. 1, a double sprocket 54 or a whole unit hub sprocket may be attached to the bottom rotor 42 so that a second chain may be attached to the sprocket 54 of the bottom rotor 42 and extend to the sprocket 52 of the top rotor 40. In this embodiment, when the drive sprocket 58 rotates the bottom sprocket 54, the top sprocket 52 will also be rotated. This allows for synchronization of the rotation of the top and bottom rotors. However, it is also contemplated that multiple hydraulic motors 61 and drive sprockets 58 may be utilized to rotate the top and bottom rotors 30 and 32 at differing speeds. A shroud, cover, housing, or door may also be added to house and/or cover the gears and hydraulic system. The housing or cover can protect the sprockets 52, 54, 56, and 58, as well as the hydraulic system 60 (including motors and pumps) from exposure to the elements and from being hit with debris during operation of the spreader 10. For example, the housing may prevent dust from building up on the hydraulic system, which could cause over heating and or create a fire.

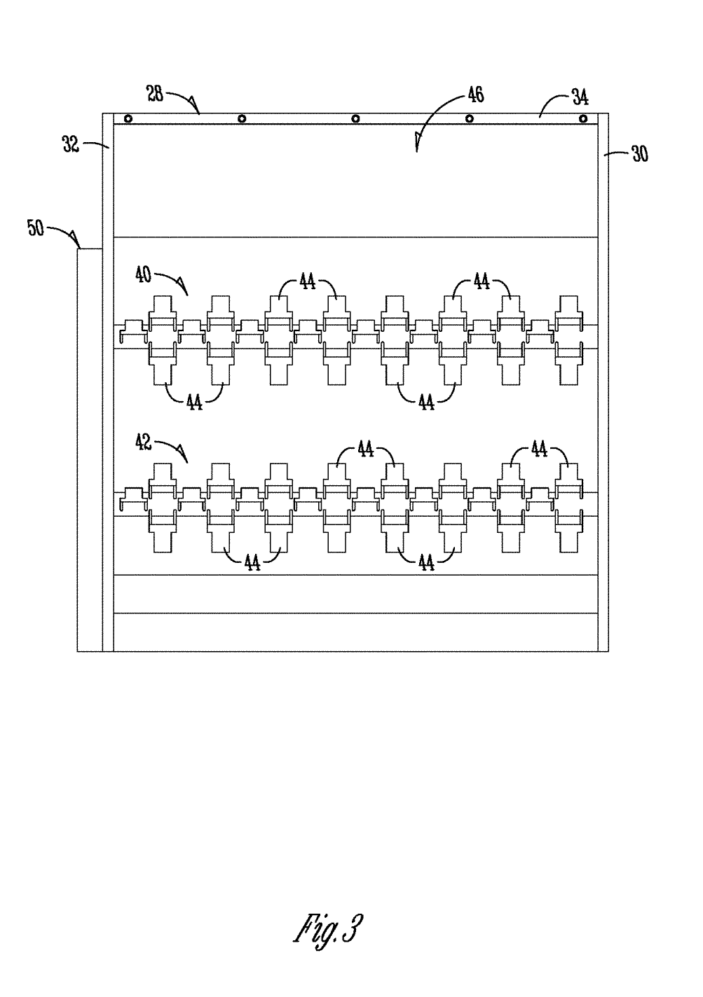

Referring to FIG. 2, a top view of the bale spreader 10 of FIG. 1 is shown. A hood 28 is attached proximate to the top of the support members 30 and 32. The hood 28 may include a top wall 34 and a front wall 29, both of which extend between the support members 30 and 32. The hood 28 creates a cavity, which the bale or particulate material is fed through as it is shredded/chopped, prior to being dispensed out the front portion of the bale spreader 10. The hood 28 may also include a rubber vacuum 46. As shown in FIG. 3, the rubber vacuum 46 may be attached to the rearward edge of the top wall 34, and extend downward on the rearward side of the support members 30 and 32. The rubber vacuum 46 may be attached by screws, bolts, hinges, adhesive, or other similar means of attachment. The rubber vacuum 46 may be constructed of a rubber or other similarly flexible material. The rubber vacuum 46 is intended to be flexible enough to allow a large bale or particulate material to pass under the vacuum 46 as it is fed into the rotors 40 and 42, yet rigid enough to withstand particulate material being thrown into the under-side vacuum 46 as the rotors 40 and 42 shred/chop the particulate material. Furthermore, as the rotors 40 and 42 are rotated, a vacuum is created within the cavity defined by the support members 30 and 32 and the hood 28. The rubber vacuum is configured and constructed of a material to help hold the vacuum effect created by the rotors 30 and 32.

A deflector shield 36 may be pivotally connected to the bottom of the front wall 29. The deflector shield 36 may include a support arm 38 that allows for the angle of the deflector shield to be adjusted. For example, if the user intends to spread the particulate material outward, the support arm 38 may be fully extended to position the deflector shield 36 to be generally perpendicular to the ground. However, if the user intends to spread the particulate material in a smaller or more defined area, the deflector shield may be lowered to direct the particulate material in a more downward direction as it exits the cavity defined by the support members 30 and 32 and the hood 28.

As shown in FIG. 2, the base 12 may include an apron 62 configured to feed a bale or other particulate material into the rotors 40 and 42. The apron 62 may run along the base 12 and extend under the rotors 40 and 42. The apron 62 may include a pair of pintle chains 64 on opposing sides of the base 12 connected by bars or rods 68 extending laterally across the base 12 between the left rail 16 and the right rail 14. It is also contemplated additional pintle chains 64 may be utilized in the apron 62. For example, a third pintle chain 64 may be run down the middle of the base 12, between the pintle chains 64 along the outer edges of the base. The tension on the pintle chain may be adjusted by a tensioner bolt 48 attached to a sprocket or pulley of the apron 62. The bars 68 connecting the center pintle chain 64 and the left chain 64 may be staggered relative to the bars 68 connecting the center pintle chain 64 to the right chain 64. It is also contemplated that a pulley and belt system may be utilized in place of the pintle chain 64 and sprocket system shown in FIG. 2. Paddles may also be added to the bars 68 to aid in feeding the particulate material toward the rotors 40 and 42. The base 12 and/or apron 62 may be turned, ground, and/or polished to provide a smoother surface with a lower coefficient friction. The lower the coefficient of friction, the less resistance there will be sliding the bale or particulate material across the base 12. The base 12 and/or apron 62 may also be coated with a paint, epoxy, or other coating/sealant that may reduce the coefficient of friction for the surface of the base 12. Any one or a combination of these processes may improve the lifetime of the spreader 10 by preventing rusting and or other wear on the apron 62 and/or base 12. It should also be understood that similar processes may be utilized on the tines 22, screen members 24, flop bar 20, and/or the rails 14, 16, and 18.

The pintle chain 64 may be driven by the same hydraulic system 60 that rotates the rotors 40 and 42 using an electric over hydraulic control. However, an additional hydraulic motor may be utilized to rotate the pulley or sprocket system of the apron 62 independent of the rotors 40 and 42. As the sprocket(s) of the apron 62 are rotated, the bars or rods 68 are dragged along the top surface of the base 12 toward the rotors 40 and 42. The bars 68 are configured to move a bale or particulate material that is placed on the base 12 of the spreader 10 proximate to the rear rail 18 toward the rotors 40 and 42, wherein the bale or particulate material may be chopped and discharged out the opposite end of the spreader 10. The base 12 of the spreader 10 may include a plurality of apertures or holes 66 configured to allow loose particulate material to fall through the base, reducing the physical labor required of the user to clean out the bale spreader 10. For example, during operation, as a bale is fed into the rotors 40 and 42, small amount of loose particulate material may become separated from the bale prior to being fed into the rotors 40 and 42. The apertures 66 will allow the loose material to fall through the base to the ground, rather than collecting on top of the base and building up over time. The apertures 66 may be round, oval, elongated, or polygonal. These cutouts may be used for loading visibility of the user to see the bale while the unit is tipped over.

Shown in FIG. 3 is a sectional view of the bale spreader 10, representing where the bale or other particulate material would enter the rotors 40 and 42. In operation a bale is placed in the base 12 of the bale spreader 10. The auxiliary hydraulic system of the skid loader, which is operatively connected to the apron 62 is activated causing the apron 62 to rotate, moving the bale toward the rotors 40 and 42. As the bale engages the rotors 40 and 42, the flail hammers 44 chop the bale and the rotational speed of the rotors 40 and 42 projects the chopped bale outwardly and away from the bale spreader 10. The deflector 36 is selectively positioned using the support arm 38 to allow the chopped bale to freely exit or be deflected downwardly toward the ground so as not to cause damage to a building, structure or the like. The apron 62 continues to rotate and extends under rotors 40 and 42, such that the remaining chopped bale is transported to the second end 26 to clean out the bed. In one embodiment, the apron 18 extends fully under the rotors 28. The apron may also operate in reverse away from the rotors to prevent wedging of particulate material and to better control material feeding.

A bale spreader including one or more rotors for chopping and spreading particulate material has thus been described. The present invention contemplates numerous variations, options and alternatives, and is not to be limited to the specific embodiments described herein. Other changes are considered to be part of the present invention.

What is claimed is:

1. A bale spreader comprising:
a base having a left edge, a right edge, a front edge, and a rear edge;
a left side rail extending from the left edge of the base;
a right side rail extending from the right of the base;
a rear side rail extending from the rear edge of the base;
opposing first and second support members extending from the front edge of the base;
a top rotor and a bottom rotor operably positioned between the first and the second support members;
a double sprocket operatively attached to the bottom rotor; and
wherein the top rotor and the bottom rotor are interconnected by one or more drive chains.

2. The bale spreader of claim 1, further comprising a flop bar member removably attached to the rear side rail, wherein the flop bar member is configured to extend in a generally vertical direction from the rear side rail.

3. The bale spreader of claim 1, wherein the top rotor and the bottom rotor further comprise a plurality of flail hammers, said plurality of flail hammers are removably attached to the top and the bottom rotors.

4. The bale spreader of claim 1, further comprising an attachment plate mounted on the left side rail or the right side rail; wherein the attachment plate is configured to attach the bale spreader to an agricultural vehicle.

5. The bale spreader of claim 4, wherein the agricultural vehicle is a skid steer.

6. The bale spreader of claim 4, further comprising a plurality of tines extending from the side rail opposite the attachment member or the adjacent side.

7. The bale spreader of claim 6, wherein the plurality of tines further comprise a tine screen extending between each of the plurality of tines, said tine screen configured for loading of loose agricultural particulate on the base.

8. The bale spreader of claim 4, further comprising a screen panel removably attached to and extending from the side rail that is proximate the attachment plate.

9. The bale spreader of claim 1, further comprising a hood connected to the first and second support members.

10. The bale spreader of claim 9, wherein the hood comprises a front wall and a top wall.

11. The bale spreader of claim 1, wherein the top rotor and the bottom rotor are staggered relative to a vertical plane.

12. The bale spreader of claim 1, further comprising an apron operatively attached to the base.

13. The bale spreader of claim 12, wherein the apron further comprises a pintle chain, said pintle chain configured to extend beneath the top and bottom rotors and to convey agricultural particulate toward the top and bottom rotors at the front of the base or away from the rotors toward the rear of the unit.

14. The bale spreader of claim 12, wherein the apron with an electric over hydraulic control and the top and the bottom rotors are driven by an auxiliary hydraulic system.

15. The bale spreader of claim 1, further comprising a rubber vacuum operatively attached to a hood extending between the opposing first and second support members, said rubber vacuum configured to hold the vacuum effect created when the top and bottom rotors are rotated.

16. An agricultural implement comprising:
a base having a left edge, a right edge, a front edge, and a rear edge;
opposing first and second support members extending from the front edge of the base;
a top rotor and a bottom rotor operably positioned between the first and the second support members;
a double sprocket operatively attached to the bottom rotor; and
wherein the top rotor and the bottom rotor are interconnected by one or more drive chains.

17. The agricultural implement of claim 16, further comprising flail knives removably attached to the top rotor and the bottom rotor, said flail knives configured to shred and distribute a particulate material when the top rotor and the bottom rotor are rotated.

18. The agricultural implement of claim 16, further comprising an attachment plate removably mounted proximate to the left edge or the right edge of the base; wherein the attachment plate is configured to removably attach the bale spreader to an agricultural vehicle.

19. The agricultural implement of claim 16, further comprising an apron operatively attached to the base, wherein the apron comprises a pintle chain configured to extend beneath the top and bottom rotors and to convey a particulate material toward the top rotor and the bottom rotor.

20. A bale spreader comprising:
a base having a left edge, a right edge, a front edge, and a rear edge;
a rear side rail extending from the rear edge of the base;
a flop bar removably attached to the rear side rail, said flop bar extending in a generally vertical direction from the rear side rail;
opposing first and second support members extending from the front edge of the base; and
a rotor operably positioned between the first and the second support members.
